(19) United States
(12) Patent Application Publication
(10) Pub. No.: US 2005/0076984 A1
(43) Pub. Date: Apr. 14, 2005

(54) Tire having tread structure for improving static discharging property

(76) Inventors: Jin-Young Park, Kwangju (KR); Il-Taik Jung, Kwangju (KR); Chi-Hoon Cho, Kwangju (KR)

Correspondence Address: MARTINE PENILLA & GENCARELLA, LLP, 710 LAKEWAY DRIVE, SUITE 200, SUNNYVALE, CA, 94085, US

(21) Appl. No.: 10/501,705

(22) PCT Filed: Jan. 17, 2003
(86) PCT No.: PCT/KR03/00110

(30) Foreign Application Priority Data
Jan. 19, 2002 (KR) 20023168

(51) Int. Cl. B60C 11/00; B60C 1/00; B60C 19/08

(52) U.S. Cl. 152/209.5; 152/152.1

(57) ABSTRACT

The present invention relates to a tire having a tread structure with improved electrostatic discharge properties, and more particularly, to a tire containing large amounts of silica, which has a tread structure with improved electrostatic electricity discharge properties. The tire of the present invention has a band-shaped electric discharge passage 30, which is extended from the under tread 20 to the outer surface of the cap tread 10 while being exposed to the outside of the tire through the outer surface of the cap tread 10. Thus, the tire of present invention has excellent conductivity without decreasing physical properties of the tread structure.

### TECHNICAL FIELD

The present invention relates to a tread structure of tires, and more particularly, to a tread structure, which easily discharges static electricity generated within a tire containing a great amount of silica.

### BACKGROUND ART

Recently, as the development of low fuel consumption tire is accelerated, the amount of silica used in preparing a tire is gradually increased and also the ratio of silica to carbon black is increased. Tire causes static electricity therein by friction with a road surface upon tire running. This generated static electricity is hardly discharged to the outside of cars, so that it gives a passenger unpleasant feelings by an electric shock when he or she gets in or off a car. Furthermore, the static electricity generated by friction with the road surface generates electromagnetic waves while flowing through conductive portions of the cars, so that it adversely affects delicate portions of the cars, including a car engine, etc.

Generally, in case of a tread containing carbon black, it has a volume resistivity of less than 10⁸ Ω-cm, whereas in case of a tread containing 100% by weight of silica, it has an electric resistance of 10⁹ to 10¹³ Ω-cm or above and thus no a conductivity.

In order to solve these electrostatic problems caused by the friction in the tire, a conductive cover strip is applied to the tire, or a certain amount of carbon black is compounded with a rubber compound, so that the silica rubber compound as an insulator renders conductivity. However, in the case where carbon black is applied to the tire so as to ensure conductivity of the tire, there is a problem in that specific resistance of a tread is decreased, but a low fuel consumption property of the silica-containing tire is remarkably deteriorated. Furthermore, another problem is that the reinforcement of polymer with the conductive carbon black is very low, so that abrasion resistance of the tire can be deteriorated.

Also, in case of a method where water base cements mixed with the conductive carbon black is coated on the rubber surface of a tread cap layer, there is a disadvantage in that workability is decreased due to very low adhesion of the cement. Furthermore, due to a problem associated with the storage of the cement itself, there is a disadvantage in that the coated cement may be detached or be a pollution source of a mold during vulcanization. In particular, during the vulcanization, adhesion at the interface between the rubber of the tread cap layer and the rubber coated on the water base cement is decreased, and hence, when tire running, detachment at the interface occurs, and at the end of the tire running period, a conductive passage at the interface is broken, so that there is no antistatic effect.

In addition, there is another method where a conductive spray is applied to a tire. However, this method maintains electric discharge up to a certain level of abrasion of the tire, whereas it cannot provide the conductive passage, i.e., the electric discharge passage after the abrasion of the tire is completed.

### DISCLOSURE OF INVENTION

Therefore, the present invention has been made in view of the above problems, and it is an object of the present invention to provide a tire where a tread structure is modified without deteriorating abrasion resistance or low fuel consumption of the tire in such a manner that the tread structure has a electric discharge passage, by which frictional static electricity generated within the tire is discharged to the outside of the tire. To accomplish the above object, the present invention provides a tire having a tread structure comprising a cap tread forming the circumferential surface of the tire and an under tread disposed on the inner surface of the cap tread, in which the tread structure includes a band-shaped electric discharge passage, which is extended from the under tread to the outer surface of the cap tread while being exposed to the outside of the tire through the outer surface of the cap tread.

The tire of present invention has an excellent conductivity without decreasing physical properties of the tire tread.

### BRIEF DESCRIPTION OF THE DRAWINGS

Further objects and advantages of the invention will be more fully understood from the following detailed description taken in conjunction with the accompanying drawings in which:

FIG. 1 is a partial cross-sectional view illustrating a tire having a tread structure with improved electrostatic discharge properties according to an embodiment of the present invention;

FIG. 2 is a partial cross-sectional view illustrating a tire having a tread structure with improved electrostatic discharge properties according to another embodiment of the present invention;

FIG. 3 is a bottom view illustrating a tire having a tread structure with improved electrostatic discharge properties according to still another embodiment of the present invention; and

FIG. 4 is a perspective view illustrating a portion of a tire having a tread structure with improved electrostatic discharge properties according to still another embodiment of the present invention.

### BEST MODE FOR CARRYING OUT THE INVENTION

A tread structure of a tire according to the present invention will now be described in detail in connection with preferred embodiments with reference to the accompanying drawings. For reference, like reference characters designate corresponding parts throughout several views.

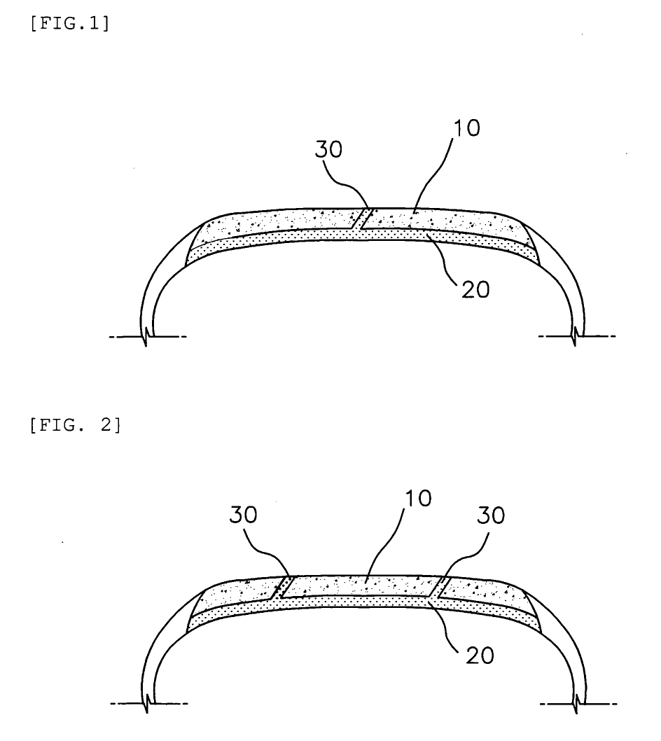

FIG. 1 is a partial cross-sectional view illustrating a tire having a tread structure with improved electrostatic discharge properties according to an embodiment of the present invention

Referring to FIG. 1, the tread structure of a tire includes a cap tread 10 forming the circumferential surface of the tire, and an under tread 20. The under tread 20 is disposed below the cap tread 10 in such a manner that it is in contact with the inner surface of the cap tread 10 and connected to the inside of the tire.

As shown in FIG. 1, an electric discharge passage 30 is preferably made of the same material as the under tread 20. Also, the discharge passage 30 is formed in a band shape to be connected to the outer surface of the tread structure. Namely, the discharge passage 30 is extended from the inner surface of the under tread 20 to the outer surface of the cap tread 10 such that it is exposed to the outside of the tire and thus can be in contact with the ground.

A rubber composition for forming the cap tread 10 preferably contains silica at the amount of more than 50 wt % relative to the weight of the rubber composition or at the amount of 70% by weight relative to the total weight of fillers. The rubber composition, which is an insulator having an electric resistance of 10⁹ to 10¹³ Ω-cm or above, cannot discharge any static electricity generated in a car body to the ground. The rubber composition for forming the cap tread 10 is not limited to the rubber composition containing silica. For example, solution-polymerized styrene-butadiene rubber, emulsion-polymerized styrene-butadiene rubber, or natural rubber alone, or a mixture thereof may be used in the rubber composition, to which a great amount of silica as a filler is compounded. Other known compounding materials used in conventional rubber compounds, including vulcanizing agents, vulcanization accelerators, vulcanization accelerating assistants, softening agents, antioxidants, etc., may also be used in the rubber composition.

Meanwhile, a rubber composition for forming the under tread 20 preferably contains up to 100 by weight of carbon black (C/B), and the discharge passage 30 is also formed of the same rubber composition as the under tread 20. The rubber composition for forming the discharge passage 30 has an electric resistance of less than 10⁸ Ω-cm, so that it can easily discharge frictional static electricity generated at the inside of the tread.

In other words, in the tire having the tread structure with an improved static-discharging property according to the present invention, the rubber composition of the outermost cap tread 10 forming the circumferential surface of the tire has a high silica content to make rotational resistance and brake force of the tire excellent. At the same time, the rubber composition of the under tread 20 has a high carbon black content such that frictional static electricity generated within the cap tread 10 of the tire is collected in the under tread 20 and then discharged through the discharge passage 30 to the outside of the tire. Also, a portion of the under tread 20 is extended from the bottom to surface of a tread structure in a given form so that fractional static electricity generated within the tire can be discharged to the tread surface and the ground.

High electric resistance according to the high silica content of the cap tread 10 is overcome by the under tread 20, so that static electricity is easily discharged to the outside of the tire through the discharge passage 30 while the tire with an advantage of low fuel consumption is obtained. The inclined angle of the discharge passage 30 extended from the under tread 20 to the outer surface of the cap tread 20 must preferably be 90° to 180°.

The reason why the discharge passage 30 according to the present invention is made inclined as described above is because a load vertically transferred to the discharge passage 30 is reduced unlike the prior vertical-type discharge passage, so that the separation between the cap tread 10 and the discharge passage 30, which is caused by corner running and vertical load, is inhibited. According to experiments and experiences, an effective and substantial reduction in vertical load is obtained at an inclined angle of more than 110°.

Furthermore, the inclined discharge passage 30 has a larger ground contact surface than that of a discharge passage having a vertical ground contact surface. Thus, the lager the inclined angle of the discharge passage 30, the more excellent the static electricity discharge characteristic of the discharge passage 30.

However, if the inclined angle of the discharge passage 30 is more than 130°, the production of tires will be reduced. For this reason, the inclined angle is preferably less than 130°.

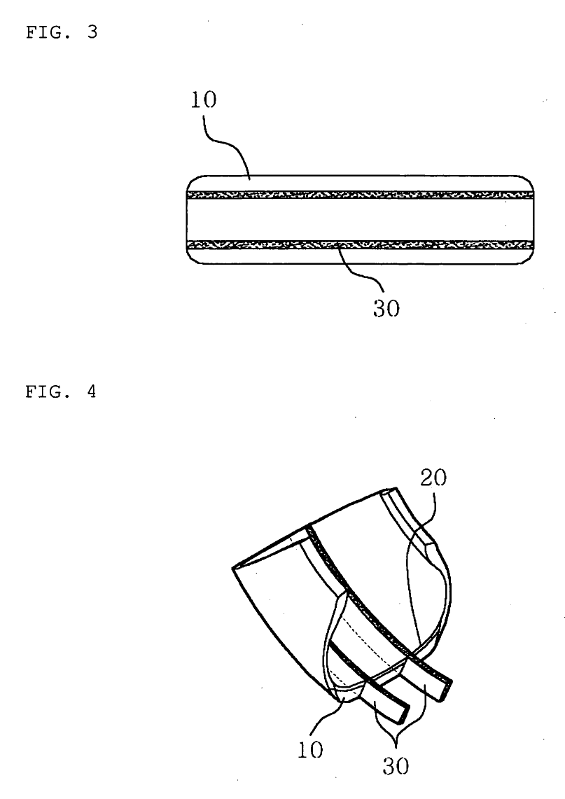

FIGS. 2 to 4 show tire tread structures according to other embodiments of the present invention. In the tread structures shown in FIGS. 2 to 4, one more discharge passage 30 than that of the embodiment of FIG. 1 is formed, so that frictional static electricity collected in the under tread is more efficiently discharged to the ground.

Industrial Applicability

As described above, the tire having the tread structure with improved electrostatic discharge properties according to the present invention has an advantage in that the tire can easily discharge frictional electricity generated in the tread structure to the outside of the tire, without decreasing physical properties of the tread structure, such as abrasion resistance, rotational resistance and brake force, in order to increase conductivity of the tread structure.

Particularly, the inclined discharge passage forming the tread structure according to the present invention is difficult to be separated from the cap tread by vertical load, and thus have a structural stability. Also, the inclined discharge passage has a larger ground contact surface than that of a vertical-type discharge passage, indicating an improved static electricity discharge function.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. In a tire having a tread structure in which silica is contained in a tread at an amount of more than 50 wt %, and a carbon black-containing electric discharge passage serving to discharge static electricity generated within the tire to the ground is formed, the improvement wherein one or two band-shaped electric discharge passages 30 are formed in the tread structure in such a manner that they are extended from an under tread 20 through a cap tread 10 to the outer surface of the cap tread and have an inclined angle of 110-130°.

2-5. (canceled)
